(19) United States
(12) Patent Application Publication
(10) Pub. No.: US 2018/0144256 A1
(43) Pub. Date: May 24, 2018

(54) Categorizing Accounts on Online Social Networks

(71) Applicant: Facebook, Inc., Menlo Park, CA (US)

(72) Inventors: Sanchan Sahai Saxena, Milpitas, CA (US); Alvin Ko, San Francisco, CA (US); Veera S. Mutakana, Santa Clara, CA (US); Youssef Ahres, San Francisco, CA (US)

(21) Appl. No.: 15/358,943

(22) Filed: Nov. 22, 2016

(51) Int. Cl. G06N 5/04; G06N 99/00

(52) U.S. Cl. CPC G06N 5/04; G06N 99/005

(57) ABSTRACT

In one embodiment, a method includes using a processing system to access a first set and a second set of user accounts in an online social network. The first set and second set of user accounts are predetermined as belonging to a first category and a second category, respectively. From each user account in the first and second set, the system may extract feature values corresponding to a set of predetermined feature types, which includes at least a feature type relating to profile information and at least a feature type relating to posting information. The system may then train a machine-learning model using the extracted feature values. The trained machine-learning model may be configured to predict whether a third user account in the online social network belongs to the first category or the second category, based feature values corresponding to the feature types extracted from the third user account.

### TECHNICAL FIELD

This disclosure generally relates to a method of using machine learning to automatically predict or classify particular categories or types of user accounts on online social networks.

### BACKGROUND

An online social-networking system, which may include a social-networking website, may enable its users (such as persons or organizations) to interact with it and with each other through it. The social-networking system may, with input from a user, create and store in the social-networking system a user profile associated with the user's account. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

Online social networks have become a common platform for individuals and businesses alike to establish online presences. Different users use their social-networking accounts for different purposes. For example, individuals using an online social network for personal purposes may use their accounts to provide personal information and stay connected with friends and family. Business users, on the other hand, may provide, e.g., business information, marketing information, promotional information, and merchandise/service information through their social-networking accounts. However, despite potentially different usage patterns between individuals and businesses, online social networks may not differentiate or categorize user accounts to reflect their usage patterns (e.g., users may not be required to self-categories or self-identify). The lack of such information may limit the ability of the online social network to tailor its services to better meet the needs of its users.

### SUMMARY OF PARTICULAR EMBODIMENTS

In particular embodiments, a social-networking system may use machine learning to automatically determine if a user account is being used in a particular manner of interest (e.g., business or non-business/personal purpose). For example, a machine-learning model may be trained using machine learning algorithms to analyze information associated with a user account and predict whether the account belongs to a particular predetermined category. Account information may include, for example, profile information (e.g., biographical information, website link, contact information, name, etc.), posting information (e.g., messages, comments, reviews, affinities, pictures, and videos posted on the social-networking system, along with associated metadata), and other suitable information. An example supervised machine-learning process may include extracting feature values from (1) a training set of user accounts known to belong to a first category (e.g., accounts used for business purposes) and (2) a training set of accounts known to belong to a second category (e.g., accounts used for non-business purposes). The extracted features and their association with known categories or account types may be used to train a machine-learning prediction model. Once trained, the machine-learning model may be used to analyze similarly extracted feature values from an account of unknown usage type and predict how the account should be categorized/classified (e.g., whether the account is likely being used for business or non-business purposes). The trained machine-learning model thus transforms an otherwise generic computer processing system into a specialized system capable of automatically categorizing user accounts. The embodiments disclosed herein for training the machine-learning model overcome the technical challenge of generic computer processing systems being otherwise incapable of automatically categorizing user accounts with sufficient precision and recall. Benefits of the various embodiments disclosed herein include, without limitation, allowing social-networking systems to quickly and automatically identify particular user accounts of interest without needing human intervention or input, and allowing social-networking systems to not require users to self-identify or self-classify, thereby simplifying the registration process or user experience.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates example components for training and using a machine-learning model for classifying or predicting categories/types of user accounts in an online social network.

FIG. 4 illustrates an example method for training a machine-learning model for classifying or predicting categories/types of user accounts in an online social network.

FIG. 5 illustrates an example method for using a trained machine-learning model for classifying or predicting categories/types of user accounts in an online social network.

FIG. 6 illustrates an example computer system.

### DESCRIPTION OF EXAMPLE EMBODIMENTS

### System Overview

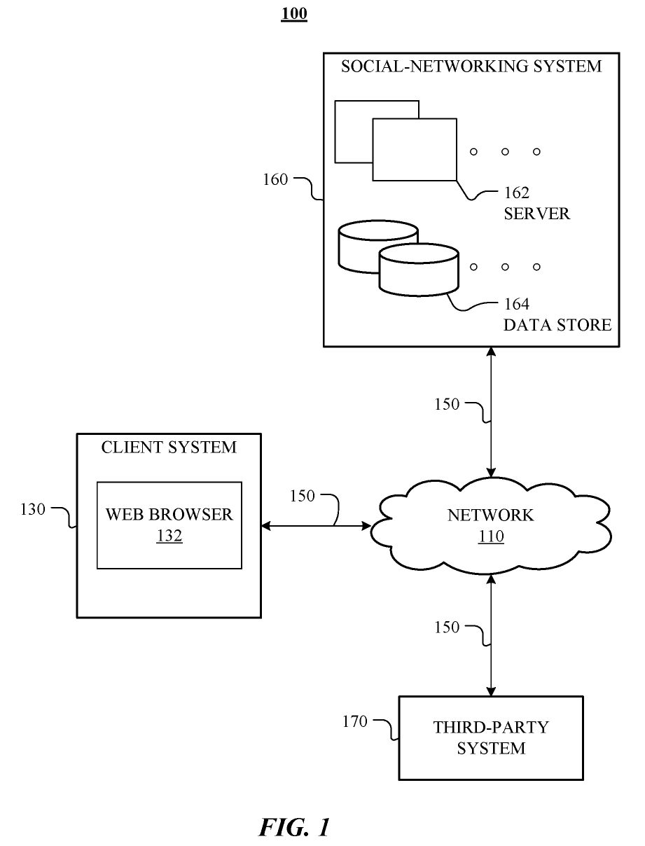

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, user posting information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

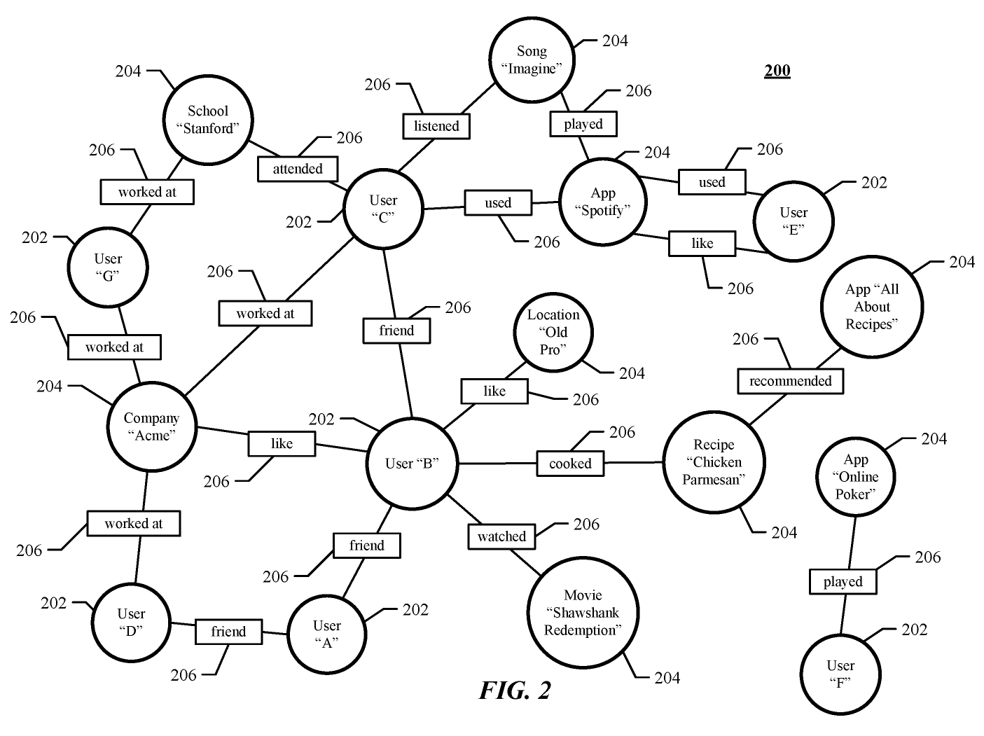

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party system 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other interactable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), sub scriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to an edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Categorizing Accounts

In particular embodiments, the social-networking system 160 may use machine learning to determine if a user account is being used in particular manners of interest (e.g., business or non-business/personal purposes). For example, a machine-learning model or classifier may be trained using machine learning to analyze information associated with a user account and predict whether the account belongs to a particular predetermined category. Account information may include, for example, profile information (e.g., biographical information, website link, contact information, name, etc.), posting information (e.g., messages, pictures, and videos posted on social media along with associated metadata), and other suitable information. An example machine learning process may include extracting feature values from (1) a training set of accounts known to belong to a first category (e.g., accounts used for business purposes) and (2) a training set of accounts known to belong to a second category (e.g., accounts used for non-business purposes). The extracted features and their association with known categories or account types may be used to train a machine-learning prediction model. Once trained, the machine-learning model may be used to analyze similarly extracted feature values from an account of unknown usage type and predict how the account should be categorized/classified. As an example and not by way of limitation, a machine-learning model may be used to predict whether a user account is being used in particular patterns, such as for connecting with friends and family, career networking, communicating or providing content to subscribers or followers, etc. As another example and not by way of limitation, an embodiment of the machine-learning model may be used to predict whether a given user account of an online social network is being used for business purposes (e.g., marketing, sales of goods or services, promotions, etc.). Although this disclosure describes training a machine-learning model in a particular manner, this disclosure contemplates machine learning in any suitable manner.

In particular embodiments, the social-networking system 160 may access a first plurality of user accounts in an online social network. The first plurality of user accounts may be predetermined as belonging to a first category. As an example and not by way of limitation, the social-networking system 160 may access a set of training data, which may be a collection of user accounts in the online social network known to belong to a particular category, such as accounts used for business purposes. The training data may be determined based on, for example, manual inspection of user accounts, user accounts that have self-designated as belonging to the particular category, random sampling of a candidate pool with members that predominantly belong to the particular category, other suitable means, or any combination thereof. Although this disclosure describes accessing and identifying training data in a particular manner, this disclosure contemplates accessing and identifying training data in any suitable manner.

In particular embodiments, the social-networking system 160 may access, by the computer processing system, a second plurality of user accounts in the online social network. The second plurality of user accounts may be predetermined as belonging to a second category (which may be different from the first category). As an example and not by way of limitation, the social-networking system 160 may access a set of training data, which may be a collection of user accounts in the online social network known to belong to a second particular category, such as accounts used for non-business purposes. The training data may be determined based on, for example, manual inspection of user accounts, user accounts that have self-designated as belonging to the particular category, other suitable means, or any combination thereof. For instance, training data of user accounts belonging to a particular category (e.g., accounts used for non-business purposes) may be obtained by randomly sampling a pool of user accounts that are predominantly of that category (e.g., 95%, 97%, 99%, etc. of the accounts in the pool belong to that category). Although this disclosure describes accessing and identifying training data in a particular manner, this disclosure contemplates accessing and identifying training data in any suitable manner.

In particular embodiments, the social-networking system 160 may extract feature values corresponding to a set of predetermined feature types from each of the first plurality of user accounts and each of the second plurality of user accounts. For example, the system 160 may process each of the user accounts in the training data sets used for training the machine-learning model and extract features of interest as set forth by the predetermined feature types or classifiers. In particular embodiments, the set of predetermined feature types may comprise at least a first feature type relating to profile information (e.g., including biographical information and other information set forth above) associated with the corresponding user account. As an example and not by way of limitation, feature types relating to profile information may be based on a word-length measure of the profile information, occurrences of predetermined words in the profile information, an aggregation of coefficients associated with the predetermined words, word vectors occurring in the profile information, paragraph vectors occurring in the profile information, and/or whether a website link satisfying a predetermined format occurs in the profile information. In particular embodiments, the set of predetermined feature types may comprise at least a second feature type relating to posting information associated with the corresponding user account. As an example and not by way of limitation, the second feature type relating to posting information may be based on occurrences of tagging metadata in the posting information (e.g., hashtags or other metadata associated with media posted on the online social network), a frequency of a tagging metadata occurring in the posting information, a determination of similarities between images included in the posting information (e.g., as determined by clustering the images based on distances between feature vectors extracted from the images), and a time at which the posting information was posted. Although this disclosure describes extracting features in particular manners, this disclosure contemplates extracting features in any suitable manner.

In particular embodiments, the social-networking system 160 may train, by the computer processing system, a machine-learning model or classifier using the feature values extracted from the first plurality of user accounts and the second plurality of user accounts. As an example and not by way of limitation, the predetermined feature types may be used as the predictors or independent variables in the machine-learning model, and the predetermined categories in which the training data sets belong may be the output or dependent variable of the machine-learning model. As another example and not by way of limitation, the machine-learning model may be represented as a linear combination of weighted features. In particular embodiments, each user account in the training data sets represents a data point for training the machine-learning model. For example, the feature values extracted from a user account's information may substitute the independent variables in the machine-learning model, and the known category in which the user account belongs may substitute the dependent variable of the machine-learning model. In particular embodiments, training of the machine-learning model may involve using a machine-learning algorithm, such as regression analysis or any other suitable methods, to determine the proper weights for each of the feature types in the model. These feature weights, for example, may represent the predictiveness of the corresponding feature types, and may be used to calibrate or be incorporated into the machine-learning model to generate a trained machine-learning model. The trained machine-learning model may, for example, be configured to predict whether a given user account in the online social network belongs to the first category or the second category based on one or more feature values extracted from the user account, where the one or more feature values correspond to one or more of the predetermined feature types. Although this disclosure describes training of a machine-learning model in a particular manner, this disclosure contemplates machine-learning training in any suitable manner.

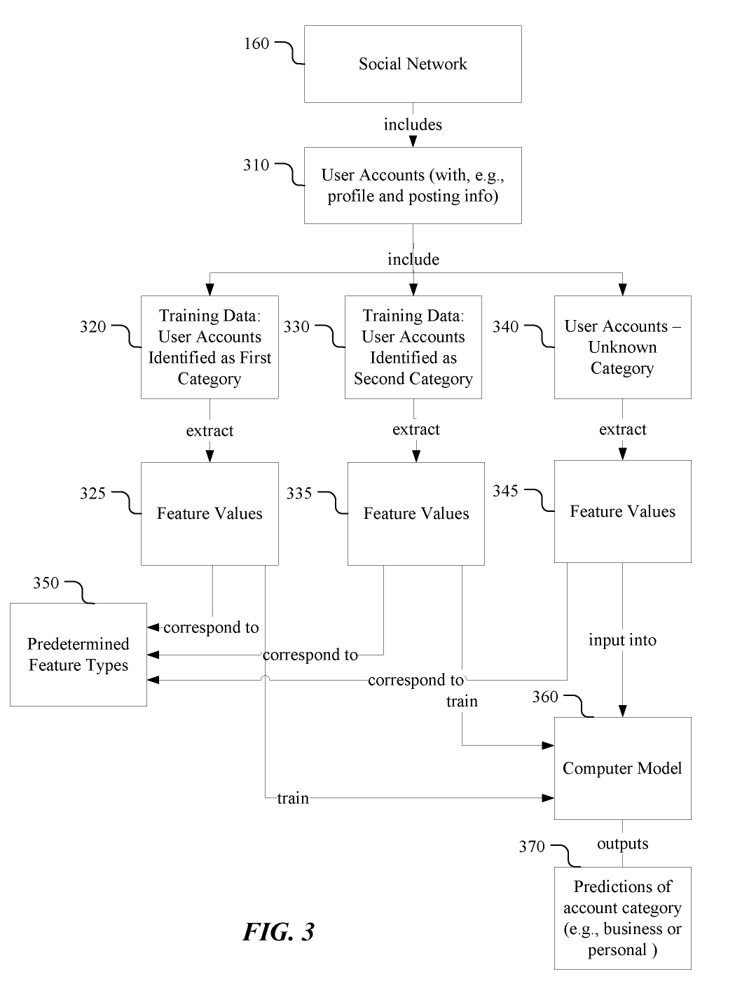

FIG. 3 illustrates example components for training and using a machine-learning model for predicting whether a social-networking account belongs to particular categories (e.g., whether a user account is being used for business or non-business purposes). In the illustrated embodiment, a social-network system 160 may include multiple user accounts 310, each of which may be associated with an account ID, user name, password, and/or other information for uniquely identifying the account. Each user account 310 may include, for example, profile information and posting information, among others. Profile information may include, for example, biographic information (e.g., a description of the user, which can be a person or an organization), contact information (e.g., e-mail, phone number, physical address), identification information (e.g., username), authentication information (e.g., password), website link or URL, and other information pertaining to the user. Posting information may include, for example, texts, images, videos, comments, reviews, and other content posted on the online social network by the user. In particular embodiments, posting information may also include associated metadata (whether system generated or user generated), such as hashtags or other content tags that identify subjects to which a post relates, the time at which posting took place, the location of the user device at the time of posting, captions for the post, affinity or sentiment towards posts (e.g., whether the user “likes” a post), and any other information related to the user's posts.

In particular embodiments, the social-networking system 160 may train a machine-learning model 360 to automatically classify user accounts 310 or predict the categories in which they belong. The training data, in particular embodiments, may be obtained from the user accounts 310 of the social-networking system 160. For example, if the machine-learning model 360 is to be trained to predict or classify user accounts as either belonging to category 1 (e.g., accounts used for business purposes) or category 2 (e.g., accounts used for non-business purposes), the system may define a training data set of user accounts 320 known to belong to category 1 and another training data set of user accounts 330 known to belong to category 2. The training data sets may be determined using any practical means. For example, information associated with the pool of user accounts 310 (e.g., profile information, posting information, etc.) may be manually inspected to identify user accounts that belong to the first category, such as accounts that are being used for business purposes 320, and user accounts that belong to the second category, such as accounts that are being used for non-business or personal purposes. If certain users have self-designated their accounts as belonging to a particular category (e.g., certain users may have converted their accounts to business accounts), then the training data set representing that category may be based on those user accounts which have self-designated. In particular embodiments where it is known that a statistically predominant percentage (e.g., more than 95%, 97%, 99%, etc.) of the user accounts 310 belong to a particular category (e.g., accounts used for non-business purposes), the training data set representing that category may be determined by randomly sampling the user accounts 310. The training data set resulting from random sampling approach may therefore be noisy with a small or insignificant proportion of, e.g., business-purpose accounts. Although the example embodiments described herein refer to training a machine-learning model for predicting or classifying user accounts into two categories, it should be understood that the concepts described herein are not limited to two-category predictions/classifications and can be applied to predictions/classifications of any number of categories. As examples and not by way of limitation, the first and second categories described in the example embodiments below are accounts used for business purposes and accounts used for non-business purposes, respectively. Other examples include, e.g., whether an account represents a person or an organization, whether an account belongs to an active (e.g., avid social media contributor or influencer) or inactive user, whether an account's user belongs to a particular demographic (e.g., senior, student, artist, celebrity), and other categories of users who exhibit particular social media posting patterns similar to any of those presented herein.

In particular embodiments, the training data sets of business-purpose user accounts 320 and non-business-purpose user accounts 330 may be processed to extract information that may correlate with or be predictive of whether an account is being used for business purposes or non-business purposes. The potentially predictive information may be defined by one or more predetermined feature types or classifiers 350. Certain feature types 350 may be related to profile information. For example, feature type 350 may be defined as the word-length measure of profile or biographic information (e.g., if a profile's biographic information contains 50 words, the corresponding feature value may be 50). This feature type 350 is defined based on the observation that business user accounts tend to have significantly longer biographic information than that of non-business or personal user accounts. For instance, it is observed that the average length of a business user account's biographic information may be 11.50 words compared to 4.07 words for non-business user accounts. This discrepancy may be attributable in part to the relatively small proportion of business user accounts having empty biographic information (e.g., it is observed that 58.8% of non-business user accounts have empty biographies while only 7.7% of the business user accounts have empty biographies).

As another example, feature type 350 may be based on occurrences of predetermined words in profile information. It is observed that biographic information of accounts used for business purposes tend to include specific vocabulary, such as “contact us,” “shipping,” “handmade,” “hours,” “directions,” “about us,” etc. In one embodiment, occurrences of such predetermined words or phrases may be computed using a bag-of-words approach, such as by predefining a list of words/phrases that commonly occur in profiles of business user account. For example, a feature type 350 may be based on the number of instances where such words/phrases in the predetermined list occur in an account's profile or biographic information. In another example, a feature type 350 may be based on an aggregation of coefficients associated with predetermined words/phrases that occur in a profile. The coefficient of a word/phrase may be computed, for example, based on occurrences of that word/phrase in (1) a training set of business user accounts and (2) a training set of non-business user accounts. In one example, the coefficient of a word/phrase may be defined as the difference between (1) occurrences of that word/phrase in a training set of business user accounts and (2) occurrences of that word/phrase in a training set of non-business user accounts. For example, if the word “shipping” occurs on average 5 times in business user accounts and 1 time in non-business user accounts, the coefficient associated with “shipping” may be set to 4. Furthering this example, if a user account's profile information includes “shipping” (coefficient 4) and “direction” (coefficient 3), an associated feature value based on an aggregation of coefficients may be 7.

Content-based feature types 350 (such as using the bag-of-words approach above) may also be defined using models that capture linguistic contexts of words. In particular embodiments, a feature type 350 may be defined based on occurrences of predefined vectors that represent predictive content. For example, a feature type 350 may be defined based on occurrences of predetermined word vectors that include contextual information. Word vectors may be generated, for example, using Word2vec, which is configured to map each word in a corpus to a word vector in a vector space, where words that share common contexts in the corpus are located in close proximity to one another in the space. As another example, DocNN, which is a paragraph2vec algorithm, may map each paragraph onto a single vector. The vector representations of paragraphs may be used as the basis to determine whether a user account's profile includes content that is predictive of whether the account is being used for business or not.

As another example, a feature type 350 may be based on whether a website link satisfying a predetermined format occurs in the profile information. This feature type 350 is based on the observation that a majority (e.g., 58%) of business user accounts include a custom website URL with a unique domain (e.g., www.StoreXYZ.com) or a social media page (e.g., www.facebook.com/StoreXYZ), while only a small percentage (e.g., 6.9%) of personal accounts do. In one implementation, this feature type 350 may be a flag. For example, a corresponding feature value may be set to 1 if a user account's profile information includes a URL satisfying predetermined condition, and it may be set to 0 otherwise. Predetermined condition may be, e.g., whether a URL includes only a top-level domain (i.e., no directory path beyond the top level domain). For example, a business URL may more likely be specified as a top-level domain (e.g., www.StoreXYZ.com), whereas a personal URL is more likely to be hosted as part of a top-level domain (e.g., www.blogger.com/blogID=Smith). Thus, a corresponding feature value may be 1 if a user account has a URL with only a top-level domain, and 0 otherwise. As another example, a predetermined condition may be whether a domain known to be typically used for hosting personal web pages (e.g., blogger.com, xanga.com, etc.) is not included in a URL. In this example, a feature value may be 1 if no such domain is included in the URL and 0 otherwise.

Feature types 350 may also be related to posting information associated with user accounts, such as, e.g., social media postings of texts, photos, videos, reviews, and any associated metadata information. In one embodiment, a feature type 350 may be defined as the frequency of the most commonly used hashtag. This feature type 350 is based on the observation that accounts used for business purposes often post images and other content with a relatively high concentration of common hashtags related to the business, industry, product, service, target customer base, etc. In contrast, it is observed that user accounts for personal purposes typically use more diverse hashtags. Thus, in one embodiment, a feature type 350 may be defined as the number of posts that contain the most frequently used hashtag by a corresponding user account, divided by the total number of posts by that user account. For example, if a user account posted a total of 20 pictures, with 10 pictures having the hashtag #XYZWidget, 6 having the hashtag #XYZ Store, and 4 having other hashtags, the #XYZWidget hashtag would be recognized that most frequently used hashtag and the feature value would be 0.5 (10 divided by 20).

In another embodiment, a feature type 350 relating to posting information may be based on similarities between images posted by a user account. Businesses are likely to repeatedly post images of specific objects, such as jewelry, baked goods, clothing, electronics, etc., so finding frequently posted objects can be a strong signal of a specialized business. Based on this observation, a feature type 350 may be defined as, e.g., the size of the largest cluster of similar images posted by a user account, the size of the largest cluster normalized by total number of posts, the number of clusters above a threshold size, etc. In one implementation, computer vision or image recognition technology system may be used to identify objects in images. For example, image recognition technology may be used to extract a deep feature vector from each image, where the deep feature vector is a vector of floating numbers encoding high-level image information that can be used for classification. The extracted feature vectors may then be used to determine image similarity. For example, a clustering algorithm (e.g., k-means clustering) may be used to cluster similar vector features (and their associated images) based on a distance metric (e.g., Newton distance) between feature vectors. The clustering results may then be used to compute a feature value for the user account.

In yet another embodiment, a feature type 350 relating to posting information (e.g., picture uploads, comments, reviews, and/or affinity indications such as “likes”) may be based on the times at which the postings occurred. Temporal behavior of a business account is likely to be different from that of a non-business or personal account. For instance, business accounts may tend to post during work times (e.g., on weekdays and/or during working hours, such as between 8 AM to 6 PM), while personal accounts may be more active during non-work times (e.g., on weekends and/or during after working hours, such as after 6 PM). Such temporal metadata associated with posting information may be predictive of whether a user account is being used for business purposes or not. In one embodiment, a feature type 350 may be defined based on the time and/or date during which most of the posting activities took place. For example, posting information associated with a user account may be conceptually placed, based on the posting information's timestamp, into one of several buckets, each representing a time period during the week (e.g., Monday between 8 AM to noon, Monday between noon and 6 PM, Monday between 6 PM and midnight, Tuesday between 8 AM and noon, Tuesday between noon and 6 PM, etc.). On example feature type 350 may be defined as the time period bucket during which most of the user's posting activities took place.

Based on the predetermined feature types 350, a processing system may extract feature values 325 335 corresponding to the predetermined feature types 350 from the training data sets 320 330. For example, if one of the predetermined feature types 350 is defined as length of biographic information, each user account in the training data set of business user accounts 320 may be processed to extract a corresponding feature value 325 reflecting the length of the account's biographic information. Similarly, a feature value 335 reflecting biographic information length may be extracted from each account in the training data set of non-business user accounts 330.

The feature values 325 335 extracted from the training data sets 320 330 may then be used to train the machine-learning model 360 for predicting whether a given user account is used for business purposes. Any suitable machine-learning model and any suitable training algorithm may be used, such as linear regression, logistic regression, neural networks, nearest neighbor methods, support vector machines, etc. In one embodiment, a machine-learning model 360 may be represented by a linear combination of weighted features:

P=w₁f₁+w₂f₂+ . . . +wᵢfᵢ

where P is a dependent variable representing an account's classification as a business or non-business account; f₁ . . . fᵢ are dependent variables representing the account's feature values, and w₁ . . . wᵢ are weights or coefficients for the dependent variables. This machine-learning model 360 may be trained, for example, using linear regression analysis to determine the proper weights for the features. For example, each account in the training data sets 320 and 330 may be represented using the equation above by substituting the account's classification for the dependent variable P (e.g., P may be set to 1 if the account is from the training data set of business user accounts 320, or 0 if the account is from the training data set of non-business user accounts 330), and substituting the account's extracted feature values 325 or 335 for the independent variables f₁ . . . fᵢ. With each user account in the training data sets 320 and 330 represented by the machine-learning model 360, linear regression may then be used to train the machine-learning model 360 to find the proper values for the weights w₁ . . . wᵢ.

The trained machine-learning model 360 may then be used to predict whether any given user account 340 belongs to the first category or second category 370 (e.g., whether the account is used for business purposes or not). For example, a user account belonging to an unknown category 340 may be analyzed to extract feature values 345 corresponding to the predetermined feature types 350 (e.g., the biographic information length of the account 340). The extracted feature values 345 may then be input into the machine-learning model 360. For example, the feature values 345 may be input as the machine-learning model 360's independent variables f₁ . . . fᵢ. By analyzing the feature values 345, the machine-learning model 360 is able to predict or categories 370 whether the user account 340 belongs to the first category or the second category (e.g., used for business purposes or non-business purposes). The prediction 370, which may be represented by P above, may represent a probability or likelihood of how the user account 340 should be classified. For example, the system may determine that the user account 340 belongs to the first category if P is above a certain threshold (e.g., 66%), belongs to the second category if P is below a certain threshold (e.g., 33%), and inconclusive otherwise.

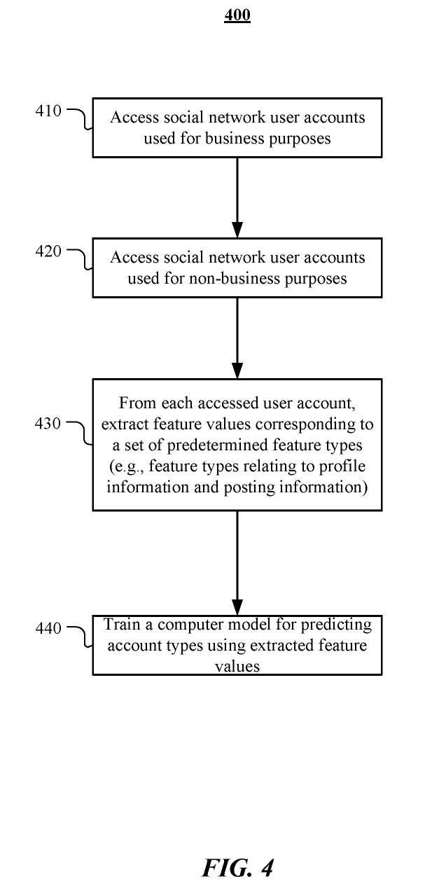

FIG. 4 illustrates an example method 400 for training a machine-learning model for classifying or predicting categories/types of user accounts in an online social network. The method may begin at step 410, where the social-networking system 160 may access a first plurality of user accounts in an online social network, the first plurality of user accounts being predetermined as belonging to a first category. For example, the system 160 may access (e.g., retrieve from storage, memory, or other data sources) user accounts that have been predetermined (e.g., manually identified) as being used for business purposes in the online social network. At step 420, the social-networking system 160 may access a second plurality of user accounts in the online social network, the second plurality of user accounts being predetermined as belonging to a second category. For example, the system 160 may access user accounts that have been predetermined as being used for non-business purposes (e.g., personal purposes) in the online social network. The user accounts accessed may serve as the training data sets for training the machine-learning model. At step 430, the social-networking system 160 may extract feature values corresponding to a set of predetermined feature types from each of the first plurality of user accounts and each of the second plurality of user accounts. For example, if the set of predetermined feature types includes X, Y, and Z, the system 160 may extract feature values Xᵢ, Yᵢ, and Zᵢ, corresponding to the feature types X, Y, and Z, respectively, from each user account i in the training data sets. As described above, the set of predetermined feature types may comprise, e.g., at least a first feature type relating to profile information (e.g., length of biographic information) associated with the corresponding user account and/or at least a second feature type relating to social network posting information (e.g., hashtags) associated with the corresponding user account. At step 440, the social-networking system 160 may train a machine-learning model using the feature values extracted from the first plurality of user accounts and the second plurality of user accounts. For example, as described above, the machine-learning model may be represented by any suitable data model (e.g., linear combination of feature values). During training, the feature values of the accounts in the training data set may be used as independent variables (or predictors) in the machine-learning model. Since the classification of each user account used in the training data sets are known (e.g., accounts used for business purposes or non-business purposes), the classification type may be used as the dependent variables in the machine-learning model. Training of the machine-learning model may be based on any suitable training algorithm. For example, regression may be used to determine how much weight should be afforded to each feature type to maximize their combined predictiveness of the dependent variable (e.g., user account categories, such as those used for business purposes or not). Once completed, the trained machine-learning model is configured to predict whether a user account in the online social network, with unknown classification, belongs to the first category or the second category (e.g., accounts used for business purposes or non-business purposes) based on one or more feature values extracted from the user account, the one or more feature values corresponding to one or more of the predetermined feature types. Particular embodiments may repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for training a machine-learning model for classifying or predicting categories/types of user accounts in an online social network, including the particular steps of the method of FIG. 4, this disclosure contemplates any suitable method for training a machine-learning model for classifying or predicting categories/types of user accounts in an online social network, including any suitable steps, which may include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

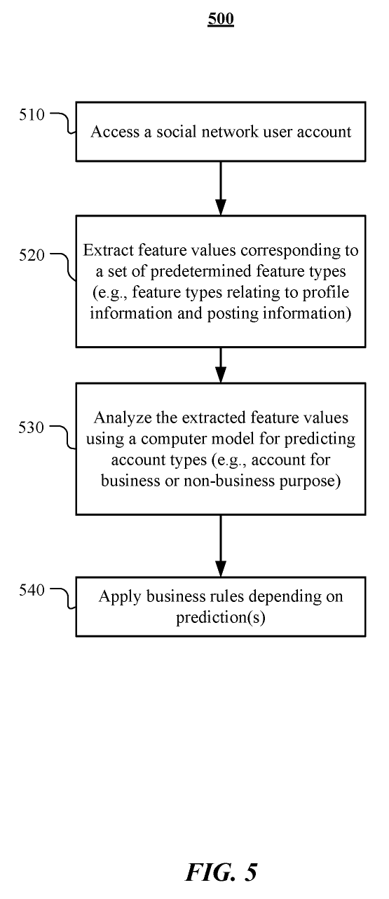

FIG. 5 illustrates an example method 500 for using a trained machine-learning model for classifying or predicting whether a user account in an online social network belongs to a particular predefined category. The method may begin at step 510, where the social-networking system 160 may access a user account in an online social network. For example, the system 160 may access (e.g., retrieve from storage, memory, or other data sources) a target user account with unknown classification or characteristic (e.g., unknown whether the user account is being used for business purposes or non-business purposes). At step 520, the social-networking system 160 may extract feature values corresponding to one or more of the predetermined feature types (e.g., relating to profile information and/or posting information) from the target user account. Continuing the example provided above where feature types X, Y, and Z were used to train the machine-learning model, the feature values extracted from the target user account k may be one or more of Xₖ, Yₖ, and Zₖ, corresponding to the feature types X, Y, and Z, respectively. In particular embodiments, the extracted feature values may correspond to a subset of the feature types (e.g., only Xₖ and Yₖ, not Zₖ₎ where it is determined that certain feature types are not predictive or should otherwise be excluded (e.g., results of the machine learning may indicate that a feature types is insignificantly predictive, which may be reflected by the weight assigned to the feature being below a certain threshold). At step 530, the social-networking system 160 may analyze the extracted feature values of the target user account using the machine-learning model to predict, classify, or categorize the target user account. For example, by the machine-learning model may take as input the extracted features from the target user account and output a prediction or classification. In some implementations, the output may be compared against predetermined thresholds to determine how the user account should be discretely classified. For example, if a first category is represented by 1 and a second category is represented by 0, a machine-learning output of 0.7 may be considered as a prediction that the corresponding user account likely belongs to the first category. At step 540, the social-networking system 160 may apply rules for determining what actions to take based on the prediction or classification. For example, the system 160 may determine whether to provide additional features or services that would target the user's needs or usage patterns. For instance, the system 160 may offer users of business accounts, e.g., business tools for tracking potential customer behavior (e.g., views, clicks, navigations, conversions, etc.) and/or an offer to switch to a business account (e.g., “It seems like you are a business. Convert to IG Business Account here.”). Additionally, the system 160 may use email, social-network postings, banner notification, or other means to offer special features to the classified users. Further, the system 160 may allow the user to import review ratings associated with his/her business from external sites, allow users to provide ratings for pictures designated as products, etc. The particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for training a machine-learning model for classifying or predicting categories/types of user accounts in an online social network, including the particular steps of the method of FIG. 5, this disclosure contemplates any suitable method for training a machine-learning model for classifying or predicting categories/types of user accounts in an online social network, including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### Systems and Methods

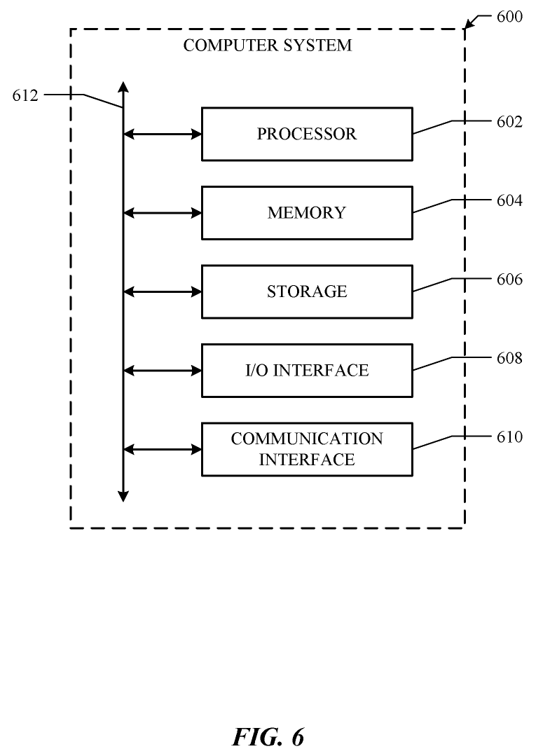

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A computer-implemented method, comprising:
accessing, by a computer processing system, a first plurality of user accounts in an online social network, the first plurality of user accounts being predetermined as belonging to a first category;
accessing, by the computer processing system, a second plurality of user accounts in the online social network, the second plurality of user accounts being predetermined as belonging to a second category;
from each of the first plurality of user accounts and each of the second plurality of user accounts, extracting, by the computer processing system, feature values corresponding to a set of predetermined feature types, wherein the set of predetermined feature types comprises (1) at least a first feature type relating to profile information associated with the corresponding user account and (2) at least a second feature type relating to posting information associated with the corresponding user account; and
training, by the computer processing system, a machine-learning model using the feature values extracted from the first plurality of user accounts and the second plurality of user accounts;
wherein the trained machine-learning model is configured to predict whether a third user account in the online social network belongs to the first category or the second category based on one or more feature values extracted from the third user account, the one or more feature values corresponding to one or more of the predetermined feature types.

2. The method of claim 1, wherein the first feature type relates to biographical information.

3. The method of claim 1, wherein the first feature type relating to profile information is based on a word-length measure of the profile information.

4. The method of claim 1, wherein the first feature type relating to profile information is based on occurrences of predetermined words in the profile information.

5. The method of claim 4, wherein the first feature type relating to profile information is further based on an aggregation of coefficients associated with the predetermined words.

6. The method of claim 5, wherein the coefficients associated with the predetermined words are computed based on (1) occurrences of the predetermined words occurring in the profile information of the first plurality of user accounts and (2) occurrences of the predetermined words occurring in the profile information of the second plurality of user accounts.

7. The method of claim 1, wherein the first feature type relating to profile information is based on word vectors occurring in the profile information.

8. The method of claim 1, wherein the first feature type relating to profile information is based on paragraph vectors occurring in the profile information.

9. The method of claim 1, wherein the first feature type relating to profile information is based on whether a website link satisfying a predetermined format occurs in the profile information.

10. The method of claim 1, wherein the second feature type relating to posting information is based on occurrences of tagging metadata in the posting information.

11. The method of claim 1, wherein the second feature type relating to posting information is based on a frequency of a tagging metadata occurring in the posting information.

12. The method of claim 10, wherein the tagging metadata are associated with media posted on the online social network.

13. The method of claim 10, wherein the tagging metadata comprise hashtags.

14. The method of claim 1, wherein the second feature type relating to posting information is based on a determination of similarities between images included in the posting information.

15. The method of claim 14, wherein the determination of similarities between images comprises:
extracting a feature vector from each of the images; and
clustering the images based on distances between the feature vectors.

16. The method of claim 1, wherein the second feature type relating to posting information is based on a time at which the posting information is posted.

17. The method of claim 1, wherein the training comprises using regression analysis.

18. The method of claim 1, wherein the first category is user accounts being used for business purposes in the online social network, and wherein the second category is user accounts being used for non-business purposes in the online social network.

19. A system comprising: a processing system; and computer-readable memory in communication with the processing system encoded with instructions for commanding the processing system to execute steps comprising:
accessing a first plurality of user accounts identified as belonging to a first category;
accessing a second plurality of user accounts identified as belonging to a second category;
from each of the first plurality of user accounts and each of the second plurality of user accounts, extracting feature values corresponding to a set of predetermined feature types, wherein the set of predetermined feature types comprises (1) at least a first feature type relating to profile information associated with the corresponding user account and (2) at least a second feature type relating to posting information associated with the corresponding user account; and
training a machine-learning model using the feature values extracted from the first plurality of user accounts and the second plurality of user accounts;
wherein the trained machine-learning model is configured to predict whether a third user account in the online social network belongs to the first category or the second category based on one or more feature values extracted from the third user account, the one or more feature values corresponding to one or more of the predetermined feature types.

20. A non-transitory computer-readable storage medium comprising computer executable instructions which, when executed, cause a processing system to execute steps comprising:
accessing a first plurality of user accounts identified as belonging to a first category;
accessing a second plurality of user accounts identified as belonging to a second category;
from each of the first plurality of user accounts and each of the second plurality of user accounts, extracting feature values corresponding to a set of predetermined feature types, wherein the set of predetermined feature types comprises (1) at least a first feature type relating to profile information associated with the corresponding user account and (2) at least a second feature type relating to posting information associated with the corresponding user account; and
training a machine-learning model using the feature values extracted from the first plurality of user accounts and the second plurality of user accounts;
wherein the trained machine-learning model is configured to predict whether a third user account in the online social network belongs to the first category or the second category based on one or more feature values extracted from the third user account, the one or more feature values corresponding to one or more of the predetermined feature types.
